(19) United States
(12) Patent Application Publication
(10) Pub. No.: US 2010/0301778 A1
(43) Pub. Date: Dec. 2, 2010

(54) Changeable Facial Expression Configuration and Changeable Facial Expression Garment Composed thereof

(75) Inventor: Chang Ho Chang, Guangdong (CN)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignee: Sun Solutions Ltd., Chang-an Town (CN)

(21) Appl. No.: 12/472,620

(22) Filed: May 27, 2009

(51) Int. Cl. H05B 37/00

(52) U.S. Cl. 315/314

(57) ABSTRACT

This invention relates to a changeable facial expression configuration, including a facial expression layer and an eyeball changeable device. The eyeball changeable device includes a light transmission eyeball body, and a light transmission eyeball pattern layer located in the light transmission eyeball body that is able to embody at least two different expressions with different colors, and a luminous body located with a certain distance in the rear area of the pattern layer that is able to respectively emit the light colors in accordance with the light colors of the eyeball pattern layer. The luminous body connects with the control circuit, and emits light alternately by the control of control circuit. The changeable facial expression configuration in the invention exhibits pattern layers alternately by the light transmission eyeball pattern layers with two or more different colors that located in the light transmission eyeball body and the LED luminous body located with a certain distance in the rear area of the light transmission pattern layers, and by omitting light with different colors from LED luminous body, to achieve a perfect effect of eye movement or wink. The utility mode has merits with simple structure and less raw material consumption, and is able to apply to in all the ornaments that need to decorate with changeable facial expression such as clothes, handbags and fruit plates.

### TECHNICAL FIELD

The invention relates to a facial expression configuration; especially refer to a changeable facial expression configuration, and the changeable ornaments composed by the changeable facial expression configuration

### BACKGROUND ART

The facial expression configuration in current technology usually is directly printed in the surface of the articles that needed to be decorated, whose representation is quite single and stiff, could not fulfill people's needs. In order to overcome such shortage, some people try to alter the facial expression of the ornaments by other representations, such as using electronic display screen to represent the facial expression. However, it would cost more to use electronic display screen; Furthermore, it could not be widely applied to our daily decoration needs, such articles that require to be cleaned by water as garment, handbag, and fruit plate and so on.

### CONTENTS OF THE INVENTION

Aiming at the shortcomings above in existing technology, this invention is to provide a simple structure, less raw material consumption.

The other aim of this invention is to provide a changeable facial expression garment composed by the changeable facial expression configuration.

To achieve the objective above, this invention adopts the following technical solution:

A changeable facial expression configuration, including a facial expression layer and an eyeball changeable device; wherein the eyeball changeable device includes a light transmission eyeball body, and a light transmission eyeball pattern layer located in the light transmission eyeball body that is able to embody at least two different expressions with different colors, and a luminous body located with a certain distance in the rear area of the pattern layer that is able to respectively emit the light colors in accordance with the light colors of the eyeball pattern layer; The luminous body connects with the control circuit, and emits light alternately by the control of control circuit.

The foresaid light transmission eyeball body is a solid eyeball structure; The inner surface of the front of the eyeball body has a light transmission eyeball pattern layer with two types of color that is able to embody at least two different expressions, while at least two LED luminous body fixed in the circuit board of the rear area of the eyeball body that is able to emit the light color in accordance with the light transmission eyeball pattern layer, and connected with the circuit control by wires.

The foresaid circuit control includes a battery compartment, a circuit board and control switch, wherein the circuit board located within the battery compartment; The right and left set of the battery compartment has right and left lugs that fastened by the belt-style magic tape or joined by the belt-style strap, wherein the upside has a fixed loop that could be stitched on the flexible base material while the underside has a bottom lug fixed on the base material; Or a fixture is located in the surface between the battery compartment and the base material.

The foresaid side edge of the light transmission eyeball has a light shielding layer, to enforce the brightness of the anterior side of the eyeball.

The foresaid changeable facial expression configuration also includes a mouth shape changeable device, wherein the mouth shape changeable device includes a light transmission mouth shape body, at least two types of light transmission mouth shape pattern layers located in the light transmission mouth shape body that in accordance with the expressions of the eyeball, and a LED luminous body located with a certain distance in the rear area of the light transmission pattern layer that is able to respectively emit the light colors in accordance with the light colors of the light transmission mouth shape pattern layer.

The foresaid light transmission eyeball pattern layer is made up by the light transmission dye layer or the transparent materials with light transmission dyes.

The foresaid light transmission mouth shape pattern layer is made up by the light transmission dye layer or the transparent materials with light transmission dyes.

A changeable facial expression garment that is composed by the changeable facial expression configuration, including the garment and the changeable facial expression configuration, wherein the changeable facial expression configuration includes a facial expression layer and an eyeball changeable device; wherein the eyeball changeable device includes a light transmission eyeball body, and a light transmission eyeball pattern layer located in the light transmission eyeball body that is able to embody at least two different expression with different colors, and a luminous body located with a certain distance in the rear area of the pattern layer that is able to respectively emit the light colors in accordance with the light colors of eyeball pattern layer; The luminous body connects with the control circuit, and emits light alternately by the control of control circuit. The facial expression layer is printed in the garment body, and in the garment body that in accordance with the eyeball location of the facial expression layer has an eyeball hole in the light transmission eyeball body; The light transmission eyeball body is fixed in the eyeball hole; The circuit board is fixed in the garment and has electric connection with the light transmission body located in the rear area of the eyeball body.

The foresaid light transmission eyeball body is a solid eyeball structure; The inner surface of the front of the eyeball body has a light transmission eyeball pattern layer with two types of color that is able to embody at least two different expression, while at least two LED luminous body fixed in the circuit board of the rear area of the eyeball body that is able to emit the light color in accordance with the light transmission eyeball pattern layer, and connected with circuit control by wires.

The foresaid changeable facial expression configuration also includes mouth shape changeable device, wherein the mouth shape changeable device includes a light transmission mouth shape body, at least two types of light transmission mouth shape pattern layers located in the light transmission mouth shape body that in accordance with the expressions of the eyeball, and a LED luminous body located with a certain distance in the rear area of light transmission pattern layer that is able to respectively emit the light colors in accordance with the light colors of the light transmission mouth shape pattern layer.

By adopting the structure stated above, The changeable facial expression configuration in the invention exhibits pattern layers alternately by the light transmission eyeball pattern layer with two or more different colors that located in the light transmission eyeball body and the LED luminous body located with a certain distance in the rear area of light transmission pattern layer, and by omitting light with different colors from the LED luminous body, to achieve a perfect effect of eye movement or wink. The utility mode has merits with simple structure and less raw material consumption, and is able to apply in all the ornaments that need to decorate with changeable facial expression such as clothes, handbags, light-fixtures, fruit plates, even gravestones.

### DESCRIPTION OF FIGURES

FIG. 1 is a structure figure of the invention;

FIG. 2 is a structure figure of another posture of the invention;

FIG. 3 is a structure figure of the eyeball changeable device.

FIG. 4 is a structure figure of another eyeball changeable device.

FIG. 5 is a structure figure of the changeable facial expression garment.

### MODE OF CARRYING OUT THE INVENTION

Further explanation to the invention will be stated below combining with the attached figures and the mode of carrying out the invention:

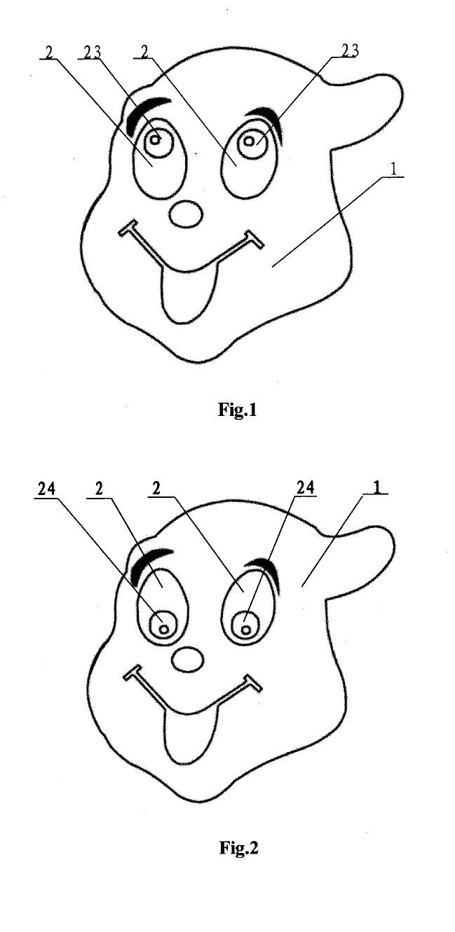

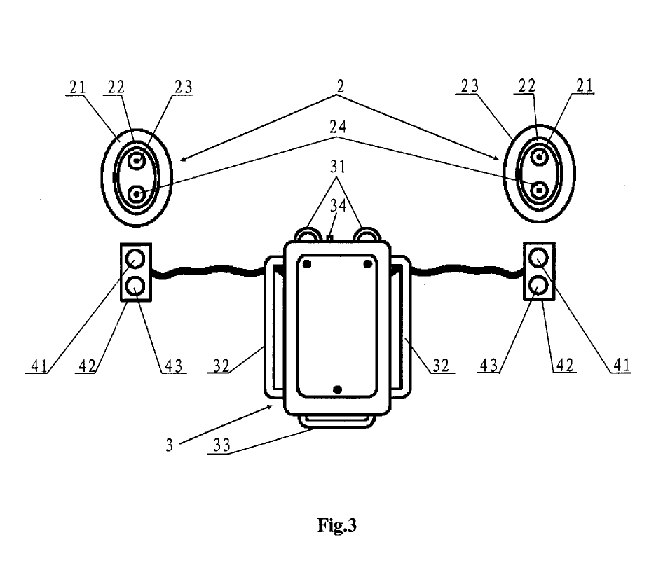

As shown from FIG. 1 to FIG. 2, a changeable facial expression configuration, characterized in that it includes a facial expression layer 1 and an eyeball changeable device 2; wherein the eyeball changeable device 2 includes a light transmission eyeball body with solid eyeball structure and made up by transparent materials. The inner surface of the front of the eyeball body has the light transmission eyeball pattern layers 23, 24 with different types of color that are able to embody at least two different expressions. The light transmission eyeball pattern layers 23, 24 are made up by the light transmission dye layer or the transparent materials with light transmission dyes. At least two LED luminous bodies 41, 43 fixed in the circuit board of the rear area of the eyeball body that is able to emit the light color in accordance with the light transmission eyeball pattern layers 23, 24, and connected with circuit control by wires. The side edge 22 of the light transmission eyeball has a light shielding layer, to enforce the brightness of the anterior side of the eyeball, while the circumference edge in the rear area of light transmission eyeball has an annular fixing part 21 that is easy to fix the light transmission eyeball body.

The circuit control includes a battery compartment 3, a circuit board and control switch 4, wherein the circuit board located within the battery compartment 3; The right and left set of the battery compartment has right and left lugs 32 that fastened by the belt-style magic tape or joined by the belt-style strap, wherein the upside has a fixed loop 31 that could be stitched on the flexible base material, while the underside has a bottom lug 33 fixed on the base material; Or a fixture is located in the surface between the battery compartment and the base material.

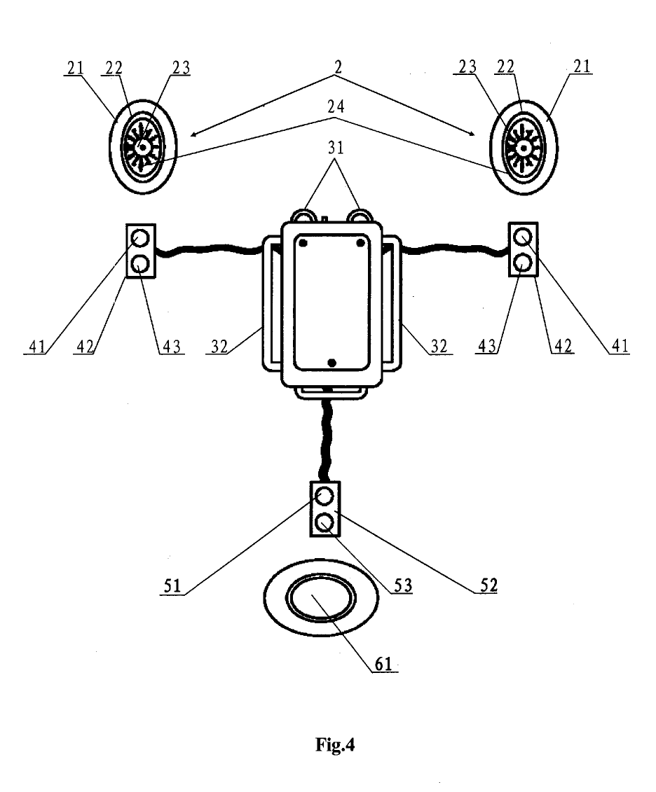

As shown in FIG. 3, it is another facial expression configuration; it adds the mouth shape changeable device by compare with the first configuration. The mouth shape changeable device includes a light transmission mouth shape body, at least two types of light transmission mouth shape pattern layer 61 located in the light transmission mouth shape body that in accordance with the expressions of the eyeball, and the LED luminous bodies 51, 53 located with a certain distance in the rear area of light transmission pattern layer 61 that is able to respectively emit the light colors in accordance with the light colors of light transmission mouth shape pattern layer 61. The LED light transmission body is fastened in circuit board 52.

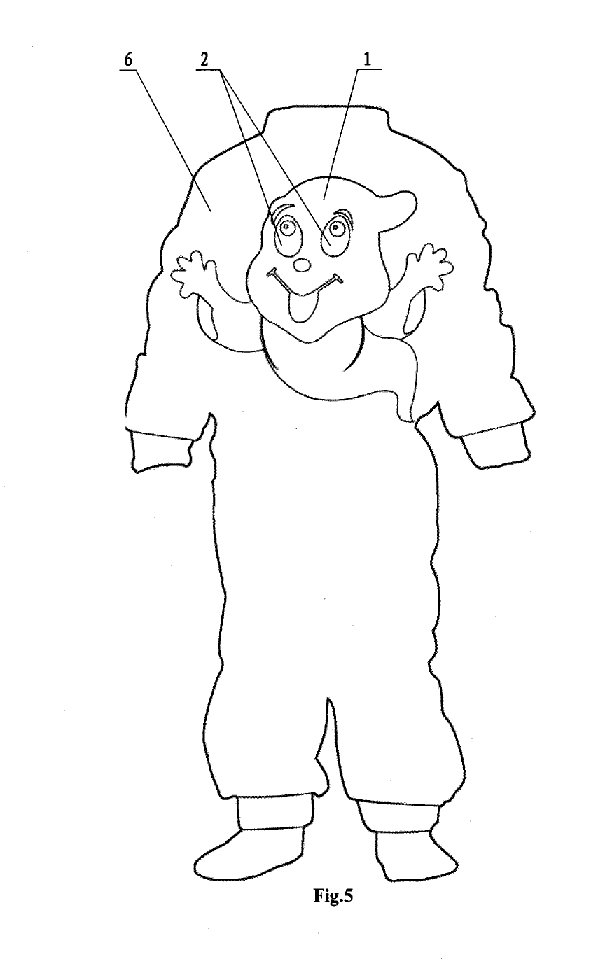

As shown in FIG. 4, it is the changeable facial expression garment that composed by the changeable facial expression configuration, including the garment 6 and the changeable facial expression configuration as shown in FIG. 1 to FIG. 3. The facial expression layer 1 is printed in the garment body 6, and in the garment body 6 that in accordance with the eyeball location of the facial expression layer has an eyeball hole in the light transmission eyeball body; The light transmission eyeball body is fixed in the eyeball hole; The circuit board is fixed in the garment and has electric connection with the light transmission body located in the rear area of the eyeball body.

The utility mode of the changeable facial expression configuration is able to apply to in all the ornaments that need to decorate with changeable facial expression such as houses, light-fixtures, fruit plates, gravestones and handbags and so on.

1. A changeable facial expression configuration, characterized in that it includes a facial expression layer and an eyeball changeable device; wherein the eyeball changeable device includes a light transmission eyeball body, and a light transmission eyeball pattern layer located in the light transmission eyeball body that is able to embody at least two different expression with different colors, and a luminous body located with a certain distance in the rear area of the pattern layer that is able to respectively emit the light colors in accordance with the light colors of eyeball pattern layer; The luminous body connects with the control circuit, and emits light alternately by the control of control circuit.

2. In accordance with the changeable facial expression configuration described under claim 1 herein and its feature is that the light transmission eyeball body is a solid eyeball structure; The inner surface of the front of the eyeball body has a light transmission eyeball pattern layer with two types of color that is able to embody at least two different expressions, while at least two LED luminous body fixed in the circuit board of the rear area of the eyeball body that are able to emit the light color in accordance with the light transmission eyeball pattern layer, and connected with circuit control by wires.

3. In accordance with the changeable facial expression configuration described under claim 1 herein and its feature is that the circuit control includes a battery compartment, a circuit board and control switch, wherein the circuit board located within the battery compartment; The right and left set of the battery compartment has right and left lugs that fastened by the belt-style magic tape or joined by the belt-style strap, wherein the upside has a fixed loop that could be stitched on the flexible base material while the underside has a bottom lug fixed on the base material; Or a fixture is located in the surface between the battery compartment and the base material.

4. In accordance with the changeable facial expression configuration described under claim 2 herein and its feature is that the side edge of the light transmission eyeball has a light shielding layer, to enforce the brightness of the anterior side of the eyeball.

5. In accordance with the changeable facial expression configuration described under claim 1 herein and its feature is that the changeable facial expression configuration also includes a mouth shape changeable device, wherein the mouth shape changeable device includes a light transmission mouth shape body, at least two types of the light transmission mouth shape pattern layers located in the light transmission mouth shape body that in accordance with the expressions of the eyeball, and a LED luminous body located with a certain distance in the rear area of the light transmission pattern layer that is able to respectively emit the light colors in accordance with the light colors of the light transmission mouth shape pattern layer.

6. In accordance with the changeable facial expression configuration described under claim 1 herein and its feature is that the light transmission eyeball pattern layer is made up by the light transmission dye layer or the transparent materials with light transmission dyes.

7. In accordance with the changeable facial expression configuration described under claim 5 herein and its feature is that the light transmission mouth shape pattern layer is made up by the light transmission dye layer or the transparent materials with light transmission dyes.

8. A changeable facial expression garment that is made up in accordance with the changeable facial expression configuration described under claim 1 herein, including the garment and the changeable facial expression configuration, wherein the changeable facial expression configuration includes a facial expression layer and an eyeball changeable device; wherein the eyeball changeable device includes a light transmission eyeball body, and a light transmission eyeball pattern layer located in the light transmission eyeball body that is able to embody at least two different expressions with different colors, and a luminous body located with a certain distance in the rear area of the pattern layer that is able to respectively emit the light colors in accordance with the light colors of eyeball pattern layer; The luminous body connects with the control circuit, and emits light alternately by the control of control circuit. The facial expression layer is printed in the garment body, and in the garment body that in accordance with the eyeball location of the facial expression layer has an eyeball hole in the light transmission eyeball body; The light transmission eyeball body is fixed in the eyeball hole; The circuit board is fixed in the garment and has electric connection with the light transmission body located in the rear area of the eyeball body.

9. In accordance with the window switching hinge described under claim 8 herein and its feature is that the light transmission eyeball body is a solid eyeball structure; The inner surface of the front of the eyeball body has a light transmission eyeball pattern layer with two types of color that is able to embody at least two different expression, while at least two LED luminous body fixed in the circuit board of the rear area of the eyeball body that is able to emit the light color in accordance with the light transmission eyeball pattern layer, and connected with the circuit control by wires.

10. In accordance with the window switching hinge described under claim 8 herein and its feature is that the changeable facial expression configuration also includes a mouth shape changeable device, wherein the mouth shape changeable device includes a light transmission mouth shape body, at least two types of light transmission mouth shape pattern layers located in the light transmission mouth shape body that in accordance with the expressions of the eyeball, and a LED luminous body located with a certain distance in the rear area of the light transmission pattern layer that is able to respectively emit the light colors in accordance with the light colors of the light transmission mouth shape pattern layer.
